(19) United States
(12) Patent Application Publication
(10) Pub. No.: US 2025/0211842 A1
(43) Pub. Date: Jun. 26, 2025

(54) Camera Device for a Glass Forming Machine

(71) Applicant: Thomas Huhn, München (DE)

(72) Inventor: Thomas Huhn, München (DE)

(73) Assignee: Emhart Glass SA, Steinhausen (CH)

(21) Appl. No.: 19/073,161

(22) Filed: Mar. 7, 2025

Related U.S. Application Data
(63) Continuation of application No. PCT/EP2023/074316, filed on Sep. 5, 2023.

(30) Foreign Application Priority Data
Sep. 7, 2022 (DE) 10 2022 122 687.5

(51) Int. Cl. H04N 23/55; G01N 21/90; G03B 9/06; H04N 23/21; H04N 23/52

(52) U.S. Cl. CPC H04N 23/55; G01N 21/9009; G03B 9/06; H04N 23/21; H04N 23/52

(57) ABSTRACT

A camera device for a glassware forming machine, comprising a camera, an objective and a lens system, wherein the lens system defines an entrance pupil on its side facing away from the objective, that the camera device has a diaphragm between the lens system and the object and a stream of blocking air is directed away from the lens system through an aperture of the diaphragm.

### CROSS-REFERENCE TO RELATED PATENT APPLICATIONS

This Patent Application is a Continuation PCT Patent Application No. PCT/EP2023/074316, filed Sep. 5, 2023, which claims priority to German Patent Application No. 10 2022 122 687.5, filed Sep. 7, 2022, the entire teachings and disclosure of which are incorporated herein by reference thereto.

### FIELD OF INVENTION

The invention relates to a camera device for a glassware forming machine with at least one camera, one lens and possibly a lens system.

### BACKGROUND OF THE INVENTION

A corresponding camera device is known, for example, from WO 2010/047579 A1. This comprises one or more cameras that are arranged in a glassware forming machine laterally below an outlet of a glass gob feeder and above a corresponding mold. The cameras are used to determine the speed of the glass gob, the direction of the glass gob speed or the like.

Another camera device of a glassware forming machine is described, for example, in U.S. Pat. No. 6,089,108, wherein a sleeve member is arranged in front of the actual camera in the direction of the object to be recorded.

A glassware forming machine may, for example, be configured to form a workpiece in the form of a bottle or other glass container from a gob of glass. A known glassware forming machine in this context is for example a so-called IS machine (IS: individual section), which has individual sections that independently of each other produce respective containers. Individual gobs of glass are cut and fed via a distribution system to the various production sections or sections. Such an IS machine is widely used in hollow glassware production. A corresponding camera device can be assigned to different areas of such a glassware forming machine, i.e. for example in an area for dispensing the glass drops, an area with the molds, an area for dispensing the still hot hollow glass products or also in a discharge area of the hollow glass products from the corresponding glassware forming machine.

In all these areas, it has been shown that camera devices for controlling and recording process variables can improve the production of the corresponding products. However, it should be noted that the camera device is exposed to considerable demands under the prevailing environmental conditions in terms of heat and contamination. The camera device should be able to capture both still images and image sequences or even film recordings of moving objects.

A disadvantage of the previously known camera devices was that, for example, due to the cyclic lubrication of molds and the resulting rising oily vapor, heat stress and other contamination, the camera's optics could only be used to an insufficient extent or not at all in a relatively short period of time.

DE 10 2004 025 666 A1 discloses an image-capturing device configured for use in material web inspection systems, for example in pulp and paper production and in the processing of paper webs. Finally, US 2015/0185592 A1 discloses a camera device that uses cleaning fluid. The underlying problem to be solved by the invention is therefore how to improve a camera device of the type mentioned at the beginning so that it can be used reliably and for a long time at various stations of a glass forming machine, even at correspondingly high temperatures and in the presence of dirt.

### SUMMARY OF THE INVENTION

The problem of the disclosure is solved by a camera device according to embodiments disclosed herein.

An embodiment is characterized in particular by the lens system defining an entrance pupil on its side facing away from the lens (i.e. facing the object), and by the camera device having a diaphragm between the lens system and the object and a blocking air flow being directed through a diaphragm opening in the direction of the object. The camera device according to an embodiment thus combines three measures which in particular prevent a corresponding camera lens from becoming dirty and at the same time largely prevent heat transfer in the direction of the camera device.

The camera device is therefore designed in such a way that an entrance pupil lies outside the area between the objective lens and the lens system of the camera device, i.e. the entrance pupil lies between the lens system and the object to be observed. The entrance pupil is the virtual opening in the object space through which a beam of rays coming from the object enters the optical system of the camera device. An embodiment is characterized in that the beam of rays, starting from the object, converges to form the entrance pupil before diverging again from the entrance pupil to the first lens of the camera device.

For this purpose, the optical system of the camera device can be constructed in such a way that a virtual intermediate image of the object, at which the beam path is in focus, is formed between two lenses of the lens system or between the lens system and the objective. A distance between the entrance pupil and the lens system may, for example, be from 40 mm to 150 mm, preferably from 50 mm to 80 mm. The distance between the entrance pupil and the lens system is the distance at which the entrance pupil lies in front of the outermost surface of the lens system.

The camera device or its lens system may be designed so that the beam at the location of the entrance pupil has a width (either FWHM, full width at half maximum, or distance between the edge rays) of 1.7 to 5 millimeters, preferably 2 to 4 millimeters. The smaller the beam width at the location of the entrance pupil, the smaller the diaphragm opening placed there can be without impairing the imaging properties of the lens system.

In the simplest case, the lens system can have a single lens, but preferably it will comprise more than one lens. In particular, the lens system can be configured as an achromatic lens system, i.e. as an achromat. The lens system can be configured as a two-lens achromat. The lenses of the lens system may, for example, have a diameter of 20 to 40 mm, preferably 25 to 35 mm. The lens system—in particular in the case of a configuration as a two-lens achromat—may have a total thickness in the axial direction of 15 to 30 mm, in particular 20 to 25 mm.

The aperture opening forms a constriction point for the optical beam path, so that already by the aperture opening dirt is largely prevented from entering in the direction of the lens system. The aperture opening represents an actual opening without a protective disc or the like covering it, as such a protective disc could become contaminated with dirt. The blocking effect of the diaphragm opening is further supported by the fact that a sealing or blocking air flow is directed through the diaphragm opening in the direction of the object. That is, the blocking air flow is directed from the direction of the camera or the lens system in the direction of the object, i.e. the object to be monitored by the camera device. The aperture opening is located close to or, preferably, essentially at the point where the beam path from the lens system is constricted to the minimum, i.e. at the entrance pupil of the lens system. Taken together, these three measures work in synergy to successfully protect the camera device against contamination and the effects of heat.

It is possible that all parts of the camera device have their own housing and are arranged one behind the other in the direction of the object. However, in order to be able to handle the camera device more easily overall, it may prove advantageous if it has a device housing in which at least the camera, lens, lens system and diaphragm are arranged. This means that all the relevant parts of the camera device can be arranged and handled together. Externally, the device housing provides a separate means of protecting the camera device from further contamination or other mechanical influences.

The distance between the lens and the lens system can be, for example, from 80 mm to 140 mm, preferably from 90 mm to 110 mm.

Depending on the object, it may prove advantageous to partially change the beam path for a corresponding image of the object or parts of the object. This can be done, for example, by varying the distance between the camera and the lens and/or between the lens and the lens system and/or between the lens system and the diaphragm.

Such variability of distance can be achieved continuously or by arranging one or more intermediate rings in the device housing between the corresponding parts of the camera device. In order to adjust a distance between the lens system and the diaphragm in a simple manner and at the same time to arrange these relative to one another, an insert part with an inner cone can be arranged between the lens system and the diaphragm. The inner cone has essentially a shape analogous to the beam path from the lens system to the diaphragm and can, for example, directly connect to the lens system and extend, for example, to the diaphragm opening, wherein a corresponding cone opening of the inner cone is associated with the diaphragm opening. However, a corresponding distance variability is also possible with respect to the insert part relative to the lens system or to the diaphragm.

To prevent disturbing reflections from the inner side of the inner cone, this inner surface can be optically neutral. That is, for example, it is non-reflective or, if necessary, also dark to black. Attention has already been drawn to the blocking air flow that escapes through the diaphragm opening in the direction of the object. In this context, it can prove advantageous if the insert has at least one air outlet that is essentially directed towards the diaphragm opening. This means that the insert is used to supply and align the blocking air flow.

In this context, it is possible, for example, that the air outlet is essentially ring-shaped or, for example, formed by a number of air outlets spaced apart from one another in the circumferential direction of the insert part.

In order to arrange and align the air outlet(s) in a simple manner, the at least one air outlet can be formed between the outside of the inner cone and a substantially cylindrical end section of the insert part. The air outlet can be geometrically shaped in such a way that it exerts a directional effect with regard to the blocking air flow or that the corresponding alignment of the blocking air flow is determined by the outside of the inner cone and cylindrical end section of the insert part.

A corresponding diaphragm with a diaphragm opening can be designed in different ways, see for example iris diaphragm, slot segment diaphragm or similar. Another conceivable and essentially simple design is the formation of the diaphragm as a pinhole. This means that the diaphragm opening is formed by a simple geometric hole in the diaphragm, which corresponds essentially in diameter to the maximum constriction point of the beam path from the lens system.

In one embodiment, all the corresponding parts of the camera device are arranged linearly one behind the other in the direction of the object, which can result in a relatively large overall length of the camera device. However, at certain stations of the corresponding glass forming machine, it may prove advantageous if the overall length is relatively small. This can be achieved, for example, by the device housing having first and second, essentially parallel receiving sections and a deflecting section connecting them. This results in a ‘folded’ beam path. At least the camera and lens can be arranged in the first receiving section, and at least the lens system, insert part and diaphragm can be arranged in the second receiving section. The corresponding deflection section serves to deflect the optical beam path, whereby the essentially parallel receiving sections can also be arranged directly next to one another with, for example, only one intermediate wall.

In order to be able to form the deflection section in a simple manner and in an optically effective way, it can have at least two essentially perpendicular deflection walls that are arranged essentially at right angles to one another and have an internal mirror. These two deflection walls serve to deflect the beam path by a total of 180°.

In order to be able to easily arrange parts of the camera device in a variable manner in their position or to be able to exchange them separately from one another, for example, all parts of the camera device can be fastened in particular in a detachable manner and can be variable in their position and in their mutual distance. It was already pointed out above that a distance variation can be carried out by arranging one or more intermediate rings.

It has already been pointed out that high temperatures can occur inside a glassware forming machine. In order to be able to detect these, in particular with regard to glass gobs, molds, objects, etc., the camera of the camera device can be a camera that is sensitive at least in the near infrared range. One example of such a camera is an infrared camera, which, however, is relatively expensive. It is also possible to use a CMOS camera, since these are usually still sensitive in the near-infrared range beyond the visible range. In order to be able to capture only this near-infrared range with this camera, the camera can be designed with a blocking filter for the essentially visible spectrum. This blocking filter filters out, for example, all frequencies up to a wavelength of approx. 750, 800, 850 nanometers (nm) or more, and only the remaining range above the corresponding wavelength up to the end of the camera's sensitivity is detected. This makes it possible to largely remove the influence of visible light and only capture radiation in the heat range. This is particularly advantageous for glassware forming machines at temperatures above 350° C., as the camera can see and measure these temperatures.

In order to change the alignment of the camera device if necessary, or to be able to use two or more camera devices together and vary their alignment, a device housing of the camera device can be pivotably mounted. In this case, a pivoting device can be part of the device housing so that it can be installed in the glassware forming machine with the corresponding pivoting device. It is also conceivable that the camera device or the device housing could be attached to a swiveling device provided in the glass forming machine.

Furthermore, it may prove advantageous if the diaphragm opening can be varied in its opening area and/or opening shape. This can change the optical properties and imaging properties of the camera device as desired.

Of course, the camera device can also be used in the optical spectrum if required, for example to detect the shape or speed of the glass gobs or the molds used to form a glass container.

In order to be able to evaluate the signals from the camera device as desired, the camera device is connected to an evaluation unit. This connection can be made via a cable connection or wirelessly. The corresponding connection to the evaluation device can also be used to change the settings of the camera device, for example, to adjust the diaphragm, to change the distance between the parts of the camera device, to swivel the device housing and the like.

The above-mentioned blocking air flow is usually generated from compressed air that is supplied to the camera device. A simple option for the supply can be seen if the device housing has a compressed air connection. A compressed air source can simply be connected to this via standard connections.

It may also prove advantageous if the blocking air flow can be used as a cooling air flow inside the device housing, in particular to cool the camera or other electrical and electronic devices in the device housing, before it exits through the diaphragm. The presence of air outlets, see the description above, results in a sufficiently strong blocking air flow in the direction of the diaphragm, so that the entry of contamination through the diaphragm opening in the direction of the camera optics is largely prevented.

An embodiment also relates to a corresponding glassware forming machine with at least one camera device according to one of the variants described above.

An arrangement of such a camera device is briefly described below for a so-called IS machine, although the camera device can also be used on other glassware forming machines, in particular in different stations of a corresponding glassware forming machine. It should also be noted that the camera technology has to fulfil different requirements at the different stations of a glassware forming machine, for example in order to detect different parameters. This means that the camera device according to an embodiment can be constructed differently in these different stations, for example, for detecting the object in the visible range, detecting the object in the near infrared range or detecting from different directions.

In a corresponding IS machine, a glass container is produced in two successive steps. The glass gob enters a preform side and is preformed there. In this first step, the mouth of the glass container is already formed and a cavity is created. After preforming, the glass container is essentially turned over so that its mouth is facing downwards. A transfer mechanism pivots the preformed object onto another side of the glassware forming machine, for example, and a finishing mold closes so that the glass container can inflate and take on its final shape. These different stations and work steps can all be monitored by the camera device according to an embodiment and the corresponding parameters of the parts or objects used can be detected. This applies, for example, to the temperature or temperature distribution of the corresponding parts, such as mouth tools, preforming tools, stamps or even preformed glass containers as objects. In addition to temperature assessment, an assessment of the incidence of the glass gobs can also be carried out; see here in particular the speed of the incident glass gob, the length of the incident glass gob, the time offset of successive gobs at one station or in different stations, and the like. It is also possible to assess the various objects with regard to, for example, glass adhering to the mold tools, trapped drops, failure of a moving mechanism of the corresponding mold tools or during the movement of a transfer mechanism, the incidence of two or more drops and the like.

In this context, it is conceivable to install one or more camera devices per station or section of the corresponding glassware forming machine. If only one camera device is used, a decision must be made regarding the appropriate installation position, which will determine whether certain parameters can be recorded and whether other parameters cannot be recorded. For example, if the camera device is installed in a center plane of the station, all the corresponding components are visible symmetrically. However, in this case, the successive drops may obscure each other as they fall, making it impossible to assess the glass drops.

In today's IS machines, between one and four drops fall in succession into the corresponding one to four mold sets per section of the corresponding machine. For a machine with only one glass drop, one camera device is sufficient, although today double and triple drops are usually used in a corresponding station. This means that it is also possible to arrange two or more camera devices in the glassware forming machine, offset laterally and/or at an angle relative to the sections or stations. With sufficient lateral offset, all the individual gobs can then be seen next to each other.

However, this may result in an asymmetrical arrangement of the camera device with respect to the mold tools.

It is conceivable, for example, to use two camera devices per section or station, so that essentially three-dimensional vision is achieved, in order to monitor an offset in different coordinate directions and also corresponding angles of incidence of the drops to a mold opening.

According to an embodiment, it is also conceivable that two cameras with corresponding optics are arranged in a device housing and, for example, enable this three-dimensional vision.

The data captured by the camera device, which can be fed to the evaluation device, can be used in different ways. For example, the data can be fed into control loops and appropriate stabilization measures can be taken with regard to the production of the glass objects. Such stabilization measures relate, for example, to changes between day and night, changes in humidity and the like, all of which can affect the manufacturing process of the glass containers and which should be appropriately adjusted in order to stabilize the overall process.

It is also conceivable to intervene in time parameters for corresponding cooling processes of the tools, to automatically switch off individual sections or stations when an exception is detected, or to track and eject containers after they have been manufactured and downstream of the corresponding glassware forming machine, after irregularities have been detected on the container, such as adhering glass, significant temperature deviation or the like. The corresponding measurement values can be used in the evaluation device not only for evaluation, but also for archiving with regard to process traceability.

In the following, advantageous embodiments are explained in more detail and described on the basis of drawings.

### BRIEF DESCRIPTION OF THE DRAWINGS

FIG. 1 a longitudinal section through a first embodiment of the camera device according to the invention,

FIG. 2 a longitudinal section through a second embodiment of the camera apparatus according to the invention, and

FIG. 3 a schematic representation of a glassware forming machine.

### DETAILED DESCRIPTION

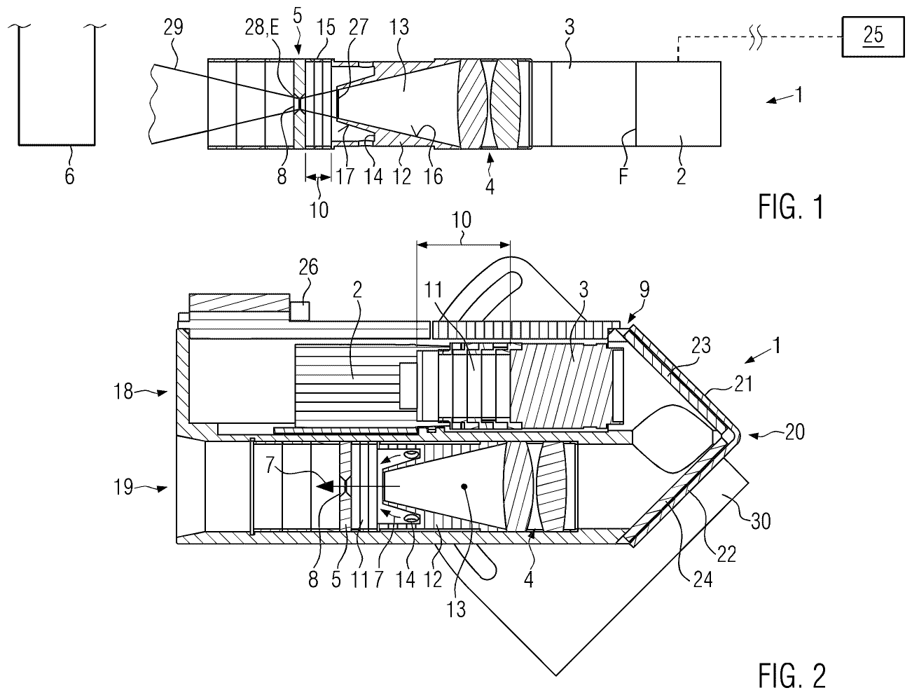

FIG. 1 shows a longitudinal section through a first embodiment of the camera device according to the disclosure, which can be used, for example, in a glassware forming machine, such as an IS machine, at different stations or sections. The camera device 1 has a camera 2, which is, for example, a CMOS camera. A lens 3 can be arranged in the camera 2 or separately from it. The camera 2 can have a blocking filter F for the visible spectrum, so that, for example, only radiation with wavelengths above 750, 800, 850 or 900 nm is detected, in particular to make a near-infrared range visible. A lens system 4 arranged in front of the objective 3 in the direction of an object 6 is also part of the camera device 1, wherein the lens system 4 is designed, for example, in a manner known per se as a two-lens system in order to correct a spectrum. However, three-lens systems 4 or other lens systems 4 can also be used. The lens system 4 can be configured as an achromat.

An insert part 12 having an inner cone 13 adjoins the lens system 4. This has an inner side 16 and an outer side 17. The insert part 12 also has an essentially cylindrical end section 15, which is arranged at a radial distance from the inner cone 13 and in particular from a corresponding cone opening 27. An annular space is formed between the cylindrical end section 15 and the inner cone 13, into which space at least one air outlet 14 opens. This releases a compressed air flow in the direction of a subsequent diaphragm 5, see also FIG. 2, and a corresponding blocking air flow 7. The air outlet 14 can also be essentially ring-shaped and formed at the connection point between the inner cone 13 and the cylindrical end section 15. The blocking air flow 7, see FIG. 2, is directed towards a diaphragm opening 8 of the diaphragm 5 and exits through this in the direction of the object 6.

In addition, FIG. 1 essentially shows a beam path 29 that has a constriction point 28 in the area of the diaphragm opening 8, i.e. the entrance pupil E of the lens system 4. h., the corresponding diaphragm 5 is arranged in such a way that the diaphragm opening 8 is assigned to this constriction point 28. The corresponding object 6 can be a part of a station or section of the glassware forming machine or also a glass object to be produced by the glassware forming machine, such as a glass container or the like.

The camera device 1 is connected to an evaluation device 25 for transmitting data or receiving control commands.

The special arrangement of the diaphragm 5 with diaphragm opening 8 prevents dirt from entering from the area of the object 6 in the direction of the lens system 4 or camera 2 with lens 3. It also provides protection against the temperatures prevailing in a corresponding glass forming machine. Contamination can result, for example, from the cyclical lubrication of molds in a glass forming machine. During such lubrication processes, clouds of oily vapors rise up and can settle on all components in the corresponding machine and also on the camera device. However, the combination of diaphragm 5 with diaphragm opening 8 and supported by the blocking air flow 7 prevents dirt from entering the lens system 4 or camera 2.

The diaphragm opening 8 can be large enough not to reduce the amount of light passing through the diaphragm 5 at all or only slightly (i.e. by a maximum of 10% or even only 5%). Thanks to its placement at or near the entrance pupil E of the lens system 4, the diaphragm opening 8 can at the same time be small enough to prevent or at least significantly reduce the penetration of dirt into the interior of the camera device 1 or onto the lens system 4.

The various components of the camera apparatus 1 can be arranged at variable distances, see for example the distance 10 in FIG. 1 or corresponding distances in FIG. 2, which can be adjusted, for example, by arranging one or more intermediate rings 11.

The example of the camera device 1 according to FIG. 1 has a relatively high overall length, since all the corresponding parts of the camera device are arranged one behind the other in the direction of object 6. In order to reduce a corresponding overall length, a device housing 9 belonging to the camera device 1, see FIG. 2, can have a first receiving section 18 and a receiving section 19, which are arranged parallel to and directly next to each other. The first and second receiving sections 18, 19 are connected to one another by way of a deflecting section 20 of the device housing 9. Parts of the camera device are arranged in each of the receiving sections 18, 19, see for example camera 2 and lens 3 in the first receiving section 18 and lens system 4, insert part 12 and diaphragm 5 in the second receiving section 19. The deflection section 20 has at least two deflection walls 21 and 22, which are arranged essentially at right angles to one another and are mirrored on their inner side or have mirrors 23, 24.

The device housing 9 can be pivotally mounted, for example on a mounting plate 30.

In order to be able to vary a distance, see for example distance 10, between the various parts of the camera device, one or more intermediate rings 11 can be arranged between the individual parts accordingly. By means of this distance variation, the camera device 1 can be adapted to various recording situations, see for example ‘wide-angle’ or ‘zoom’ or corresponding intermediate ranges.

FIG. 2 shows a plurality of air outlets 14, which are arranged approximately in the circumferential direction of the insert part 12 outside the inner cone 13 at a distance from one another. Compressed air flows through these as a blocking air flow in the direction of the diaphragm opening 8 of the diaphragm 5. In this example, the diaphragm 5 is designed as a perforated diaphragm. The corresponding blocking air flow exits through the diaphragm opening 8 in the direction of the object 6 out of the camera device 1.

The arrangement and positioning of the diaphragm opening 8 in combination with the blocking air flow 7 largely prevents any contamination occurring inside the glassware forming machine from entering the camera device 1 or at least passing through the diaphragm 5 in the direction of the lens system and the like. The corresponding direction of the blocking air flow is determined in this context not only by the arrangement and orientation of the air outlets 14, but also by the annular space between the outside 27 of the inner cone 13 and the inside of the cylindrical end section 15.

The compressed air forming the blocking air flow 7 can also be used to cool the interior of the camera device 1, in particular of camera 2 and other electrical and electronic devices within the device housing 9. For the supply of compressed air to the device housing 9, the latter has a corresponding compressed air connection 26.

FIG. 2 also shows that the (optional) blocking filter F can be arranged, for example, between the camera 2 and the lens 3, or that the blocking filter F can be arranged on the optical input side of the lens 3, for example screwed onto the lens 3.

In both FIGS. 1 and 2, a longitudinal section through the camera device 1 is shown, whereby this can have a corresponding side wall in the direction of the observer, which is part of the device housing 9 and covers all parts inside the device housing 9. A corresponding side wall is also provided, for example in FIG. 2, adjacent to the mounting plate 30.

At least one camera device 1 can be arranged in a corresponding glass forming machine. The camera of the camera device can be used, for example, to determine the temperature of the corresponding object or of other parts in sections or stations of the glassware forming machine. In general, a corresponding CMOS camera can be used in the visible spectral range, although it is also possible to measure up to the near infrared range. If the camera is to be used only for this near-infrared range, a corresponding blocking filter is used for the visible spectrum, for example, which only allows a range above 750, 800, 850 nm or more to pass, up to the end of the camera's sensitivity. This largely removes the influence of visible light and only detects radiation in the near infrared range. This is sufficient for the applications of the camera device, since this makes it possible, for example, to measure temperatures above 350° C.

The diaphragm 5 and blocking air flow 7 prevent dirt or other impurities from entering the lens system and camera even without actual shielding by, for example, a glass surface or the like. At the same time, the sealing/blocking air flow 7 and the compressed air enable the camera device 1 to be cooled.

It is possible to arrange several of the camera devices 1 in different sections or stations of a glassware forming machine, such as an IS machine, for example. This makes it possible to record certain parameters or other information during glass production, such as the temperature of the molding tools for dispensing glass gobs, the temperature of the molding tools, the temperature of the pressing plungers, the speed of the incoming glass gobs, the length of the incoming glass gobs, time lag of the glass gobs relative to one another or the movement sequence of the molding tools, as well as, of course, the temperature of the glass gobs. Furthermore, it is possible to record other parameters or information, such as glass adhering to the molding tools, crash conditions in the mold, for example, glass gobs getting stuck, failure of a transfer mechanism of the molding tools and the like.

It is also possible to combine camera devices 1 for the near infrared range and for the visible spectral range.

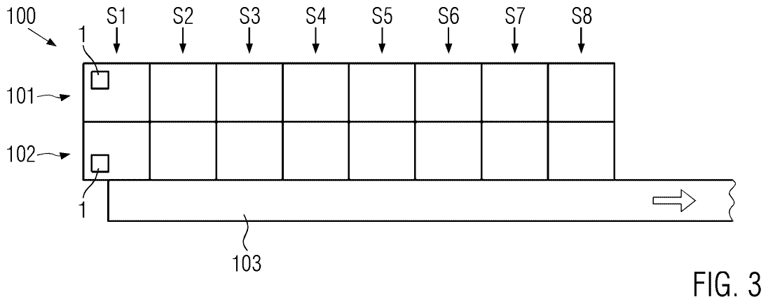

FIG. 3 schematically shows a glassware forming machine 100, for example a so-called ‘IS machine’ (IS: individual section). The glassware forming machine 100 has a preforming side 101 and a finishing side 102. In the preforming side 101, glass containers (e.g. bottles) are preformed, then transported to the finishing side 102 and finally formed there before being transported away by means of a conveyor belt 103 arranged downstream. The glassware forming machine 100 has several sections that are arranged parallel to one another, in the illustrated embodiment a total of eight sections S1 to S8. However, glassware forming machines 100 with fewer or more sections are also conceivable. Each section S1 to S8 comprises a blank mold side 101 and a finished mold side 102. At least one camera device 1 can be present in at least one, in several or even in all sections S1 to S8, namely in the blank mold side 101 and/or in the finished mold side 102.

The various camera devices 1 within the glassware forming machine can be offset and/or inclined relative to one another in such a way that, even when double, triple or quadruple gobs occur at a station of an IS machine, all these gobs and their corresponding parameters, as well as the molds and other information, can be captured. One example would be the use of two camera devices per section or station of such an IS machine. Furthermore, camera devices 1 can also be used during the discharge and further transport of the corresponding glass containers from or to the corresponding glass forming machine, for example to determine whether certain glass containers have defects, in order to sort them out if necessary.

The camera device is thus used for the safeguarding and reproducible recording of information or parameters in the glassware forming machine, wherein the corresponding data can be supplied to the evaluation device (25), for example in order to influence control possibilities of the glassware forming machine with regard to day/night change, changes in humidity, cooling processes in the glassware forming machine or the like. In this case, individual sections or stations of the corresponding glassware forming machine can also be switched off in an emergency, such as in a crash situation or the like. The recorded information and parameters can also be evaluated to the effect that a corresponding glass container is defective or inadequate if, for example, strong temperature differences occurred in the molding tools, additional glass adheres to the container or the like. In addition, the corresponding information and parameters can be archived for process traceability, and it is also possible to control the camera device 1 according to the invention from the evaluation device 25.

1. A camera device for a glassware forming machine, comprising a camera, an objective and a lens system, wherein the lens system defines an entrance pupil on its side facing away from the objective, that the camera device has a diaphragm between the lens system and the object and a stream of blocking air is directed away from the lens system through a diaphragm opening of the diaphragm.

2. The camera device according to claim 1, wherein the objective is arranged between the camera and the lens system.

3. The camera device according to claim 1, wherein the distance between the entrance pupil and the lens system is from 40 mm to 150 mmf.

4. The camera device according to claim 1, wherein the camera device has a device housing in which at least the camera, the lens, the lens system and the diaphragm are arranged.

5. The camera device according to claim 1, wherein a distance between the camera and the objective and/or between the objective and the lens system and/or between the lens system and the diaphragm is variable.

6. The camera device according to claim 5, wherein the distance can be varied by arranging one or more intermediate rings in the device housing.

7. The camera device according to claim 1, wherein an insert part with an inner cone is arranged between the lens system and the diaphragm, wherein an inner side of the inner cone is optically neutral.

8. The camera device according to claim 1, wherein the insert part comprises at least one air outlet directed substantially towards the diaphragm opening.

9. The camera device according to claim 1, wherein a number of air outlets are formed at a distance from one another in the peripheral direction of the insert part.

10. The camera device according to claim 1, wherein the at least one air outlet is formed between the outer side of the inner cone and a substantially cylindrical end section of the insert part.

11. The camera device according to claim 1, wherein the diaphragm is a pinhole diaphragm.

12. The camera device according to claim 1, wherein the device housing has first and second substantially parallel receiving sections and a deflecting section connecting the latter, wherein at least the camera and the lens are arranged in the first receiving section and at least the lens system, the insert part and the diaphragm are arranged in the second receiving section.

13. The camera device according to claim 1, wherein the deflecting section has at least two deflecting walls that are arranged essentially at a right angle to one another and each have an internal mirror surface.

14. The camera device according to claim 1, wherein all parts of the camera device are detachably mounted in the device housing and can be varied in their position and in their mutual spacing.

15. The camera device according to claim 1, wherein the camera is a camera sensitive in at least the near infrared range.

16. The camera device according to claim 1, wherein the camera is a CMOS camera with a blocking filter for the essentially visible spectrum.

17. The camera device according to claim 1, wherein the device housing is pivotally mounted.

18. The camera device according to claim 1, wherein the diaphragm opening is variable in its opening area and/or opening shape.

19. The camera device according to claim 1, wherein the camera is connected to an evaluation device.

20. The camera device according to claim 1, wherein the device housing has a compressed air connection.

21. The camera device according to claim 1, wherein the blocking air flow is used as a cooling air flow inside the device housing for cooling the camera or other electrical/electronic devices in the device housing before exiting through the diaphragm.

22. A glassware forming machine comprising one or more camera devices according to claim 1.

23. The camera device according to claim 1, wherein the distance between the entrance pupil and the lens system is from 50 mm to 80 mm.

24. The camera device according to claim 1, wherein the blocking air flow is used as a cooling air flow inside the device housing for cooling electrical/electronic devices in the device housing before exiting through the diaphragm.
